(19) United States
(12) Patent Application Publication
(10) Pub. No.: US 2008/0243685 A1
(43) Pub. Date: Oct. 2, 2008

(54) BILL PAYMENT SYSTEM

(76) Inventor: Nizam Antoo, San Carlos, CA (US)

Correspondence Address: TOWNSEND AND TOWNSEND CREW LLP, TWO EMBARCADERO CENTER, 8TH FLOOR, SAN FRANCISCO, CA, 94111, US

(21) Appl. No.: 11/695,499

(22) Filed: Apr. 2, 2007

(51) Int. Cl. G06Q 40/00

(52) U.S. Cl. 705/40

(57) ABSTRACT

A bill payment system and method. In a method, the authorization request message is sent to a biller. The authorization request message requests authorization for a consumer to pay a bill at the merchant. The biller thereafter authorizes or does not authorize payment of the bill, and then sends an authorization response message back to merchant. The authorization response message indicates whether or not the biller has authorized or not authorized the payment of the bill. The authorization response message is thereafter received by the merchant and a biller can credit an account of the consumer.

### CROSS-REFERENCES TO RELATED APPLICATIONS

NOT APPLICABLE

### BACKGROUND

A number of bill payment systems and methods are known. For example, in one conventional bill payment method, a consumer may receive a utility bill in the mail. Instead of mailing a check for the amount due on the bill to the utility that issued the utility bill, the consumer can walk into a branch office of the utility and can pay the bill at the branch office using cash. The branch office may then take the cash, record the transaction, and then transmit a message to a central computer that the bill has been paid.

In addition, some consumers tend to be “last minute” bill payers and may not have bank or credit card accounts. Such consumers may want to pay their bills on the last possible payment date, but cannot do so for a variety of reasons. For example, a biller may not even have branch offices that can accept bill payments and/or the biller's branch offices that do accept bill payments may not be convenient for the consumer.

Some have proposed using stand alone machines (kiosks) that can accept money for the payment of bills. This solution, although possible, may not be practical, because this solution requires the deployment of many specialized machines at various locations. The cost of installing many of these specialized machines would likely be cost prohibitive.

Embodiments of the invention address these and other problems, individually and collectively.

### BRIEF SUMMARY

Embodiments of the invention are directed to bill payment methods and systems, as well as computer readable media and server computers that can be used in such methods and systems.

One embodiment of the invention is directed to a method comprising receiving a bill from a biller, and then presenting tender to a merchant to pay the bill. The merchant thereafter sends an authorization request message to the biller, and the biller thereafter authorizes or does not authorize payment of the bill. The biller then sends an authorization response message back to merchant, wherein the authorization response message indicates whether or not the biller has authorized or not authorized the payment of the bill. The consumer may thereafter review the authorization response message.

Another embodiment of the invention is directed to a method comprising sending an authorization request message to a biller, where the authorization request message requests authorization for a consumer to pay a bill at the merchant. The biller thereafter authorizes or does not authorize payment of the bill, and then sends an authorization response message back to merchant. The authorization response message indicates whether or not the biller has authorized or not authorized the payment of the bill. The authorization response message is thereafter received, and may thereafter be provided to the consumer.

Another embodiment of the invention is directed to a method comprising receiving an authorization request message from a merchant. The authorization request message requests authorization for a consumer to pay a bill at the merchant, wherein the bill was previously issued by a biller. An authorization response message is then sent to the merchant, wherein the authorization response message indicates whether or not the biller has authorized or not authorized the payment of the bill.

Other embodiments of the invention are directed to systems, computer readable media, and server computers adapted to perform the above-described methods.

These and other embodiments of the invention are described in further detail below.

### BRIEF DESCRIPTION OF THE DRAWINGS

FIG. 1 shows a system according to an embodiment of the invention.

FIG. 2 shows a block diagram showing some components of an access device according to an embodiment of the invention.

FIG. 3 shows a flowchart illustrating a method according to an embodiment of the invention.

FIG. 4 shows an illustration of a bill.

FIG. 5 shows an illustration of a receipt for a bill payment.

### DETAILED DESCRIPTION

Embodiments of the invention are directed to bill payment systems and methods.

In embodiments of the invention, a biller such as a utility company can send a bill to a consumer for providing goods or services to the consumer. The bill may be sent to the consumer in any suitable manner. For example, the bill may be sent to the consumer via e-mail, in the U.S. mail, etc. It may be in the form of paper or may be in electronic form.

A biller can be any suitable entity that provides bills to consumers. Billers may or may not provide services or goods to the consumers in conjunction with the bills. For example, some billers may provide billing services for merchants that provide goods and/or services to consumers. Examples of suitable billers include, but are not limited to, utility companies, merchants such as retailers (both online and brick and mortar type merchants), telephone companies (wireless telephone carriers), gas stations, insurance companies, transit agencies, wholesalers, manufacturers, etc. Other examples of billers include governmental agencies such as the federal government, state governments, local governments, as well as agencies associated therewith.

After receiving the bill, the consumer may go to a merchant that is connected to a payment processing network. The merchant is typically one that is not specifically affiliated with the biller. For example, the merchant may be a convenience store, while the biller may be a utility. Since the merchants provide that the bill payment services need not be specifically affiliated with the biller, it is convenient for the consumer to go to any local merchant to pay his bill.

At the merchant, the consumer presents the bill to an employee of the merchant and then presents tender to the merchant. The tender is preferably in the form of cash, but may be in any other suitable form. For example, the tender may be in the form of a check (e.g., a personal or cashier's check), or even a debit, credit, or stored value card.

After receiving the bill, the merchant (e.g., an employee of the merchant) may then enter information regarding the bill as well as the amount tendered by the consumer into an access device such as a POS (point of sale) terminal. As will be explained in further detail below, the entry of information can be manual or automatic.

The access device may then send an authorization request message to the biller (which includes the biller or any suitable agent that acts on behalf of the biller). The authorization request message may include information including the amount due on the bill, the amount tendered by the consumer, the type of tender provided by the consumer, a biller account number or other identifier, a merchant identification value, and appropriate address information to route the authorization request message to the biller. Suitable address information may have the same format (e.g., the same number of digits such as six digits) as a “BIN” or bank identification number, since the authorization request message is configured to pass through payment processing network that is configured to conduct conventional debit and credit card transactions.

After the access device sends the authorization request message, the biller receives the authorization request message and can analyze it. If the authorization request message indicates that the amount tendered is equal to the amount due on the consumer's bill, then the biller can approve payment of the bill.

There may be a number of instances where the biller may not authorize payment of the bill. For example, if the authorization request message indicates that the amount tendered is less than the amount due on the consumer's bill, the biller can then make a decision as to whether or not to approve the bill payment. For example, if the amount tendered is at least 50% of the amount due on the bill, then the biller may decide to accept payment, and may then roll over the balance due onto the next month's bill. The biller may or may not assess a finance charge to the consumer for the balance. In another example, information (e.g., the account number or amount due) in the authorization request message may not match the biller's records. The biller may thereafter decline the bill payment to avoid potential accounting errors and/or may call the merchant to verify. In another example, the type of tender may or may not be acceptable to the biller. For example, if the tender is cash, the biller is more likely to approve the payment of its bill than if the tender is in the form of a personal check, which can be associated with insufficient funds.

After the biller analyzes the bill, the biller thereafter authorizes or does not authorize payment of the bill, and then sends an authorization response message back to merchant. The authorization response message indicates whether or not the biller has authorized or not authorized the payment of the bill. At the merchant, the access device at the merchant may then print out a receipt with the authorization response message indicating whether or not the transaction is approved. The receipt can serve as proof that the bill was paid.

At the end of the day or at any other suitable time interval, a clearing and settlement process can take place. During the clearing and settlement process, actual funds are transferred from an acquirer (e.g., a bank associated with the merchant) to the biller. The acquirer is expected to have relationship with its merchant and will take the necessary steps to obtain the tender that the merchant obtained from the consumer.

Further details regarding embodiments of the invention are provided in further detail below.

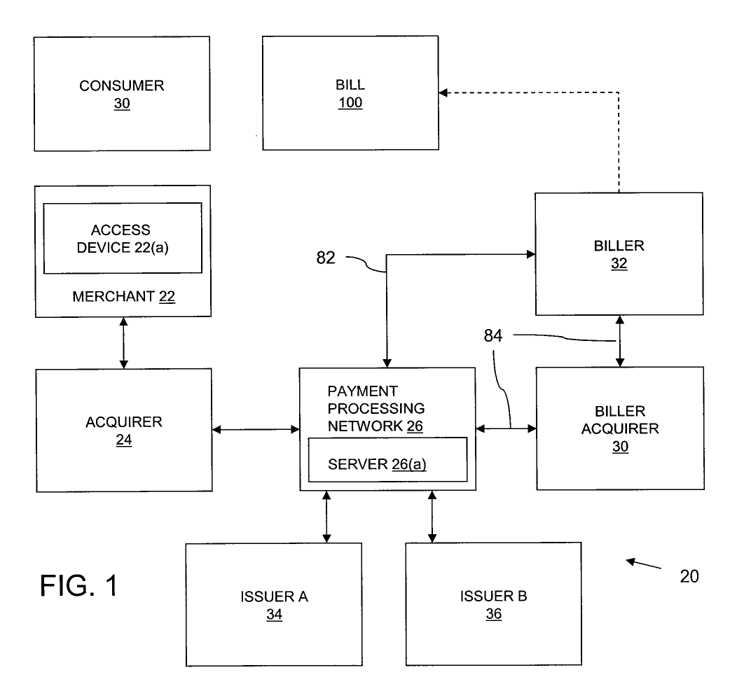

FIG. 1 shows a system according to an embodiment of the invention. Although FIG. 1 shows one specific implementation of a system, it is understood that in other embodiments of the invention, systems may include more or less components than are shown in FIG. 1.

FIG. 1 shows a system 20 that can be used in an embodiment of the invention. The system 20 includes a merchant 22 and an acquirer 24 associated with the merchant 22. The acquirer 24 is operatively coupled to a payment processing network 26, which is in turn operatively coupled to various issuers (e.g., issuer A 34 and issuer B 36), as well as a biller acquirer 30 and a biller 32.

An “acquirer” is typically a business entity, e.g., a commercial bank, that has a business relationship with a particular merchant. An “issuer” is typically a business entity (e.g., a bank) which issues a portable consumer device such as a credit or debit card to a consumer. Some entities perform both issuer and acquirer functions. Embodiments of the invention encompass such single entity issuer-acquirers.

The connections between the components in FIG. 1 may be direct or indirect connections. For example, as shown in FIG. 1, the payment processing network 26 may be directly connected to the biller 32 via the connection 82. Alternatively, the payment processing network 26 may be indirectly connected to the biller 32 via the biller acquirer (as noted above, it's also possible that the processing network may connect directly to the biller without an acquirer) 30 via the connections 84.

FIG. 1 also shows a bill 100 that the biller 32 will issue to a consumer 30. Exemplary billers are described above.

The consumer 30 may be an individual, or an organization that purchases goods or services from the biller 32. Exemplary consumers include business entities, organizations or individuals. In some embodiments, the individuals are those without bank and/or payment card accounts. Individuals without bank and/or payment card accounts are more likely use embodiments of the invention, since they cannot pay bills using conventional online methods.

The biller acquirer 30 may be a bank or other suitable organization that maintains an account that is associated with the biller 32.

The payment processing network 26 may include data processing subsystems, networks, and operations used to support and deliver authorization services, exception file services, and clearing and settlement services. An exemplary payment processing network may include VisaNet™. Payment processing networks such as VisaNet™ are able to process credit card transactions, debit card transactions, and other types of commercial transactions. VisaNet™, in particular, includes a VIP system (Visa Integrated Payments system) which processes authorization requests and a Base II system which performs clearing and settlement services.

The payment processing network 26 may include a server computer. A server computer is typically a powerful computer or cluster of computers. For example, the server computer can be a large mainframe, a minicomputer cluster, or a group of servers functioning as a unit. In one example, the server computer may be a database server coupled to a Web server. The payment processing network 26 may use any suitable wired or wireless network, including the Internet.

The merchant 22 may also have, or may receive communications from, an access device 22(a). The access device 22(a) can interact with a portable consumer device (not shown) such as a credit card.

The access devices according to embodiments of the invention can be in any suitable form. Examples of access devices include point of sale (POS) devices, cellular phones, PDAs, personal computers (PCs), tablet PCs, handheld specialized readers, set-top boxes, electronic cash registers (ECRs), automated teller machines (ATMs), virtual cash registers (VCRs), kiosks, security systems, access systems, and the like.

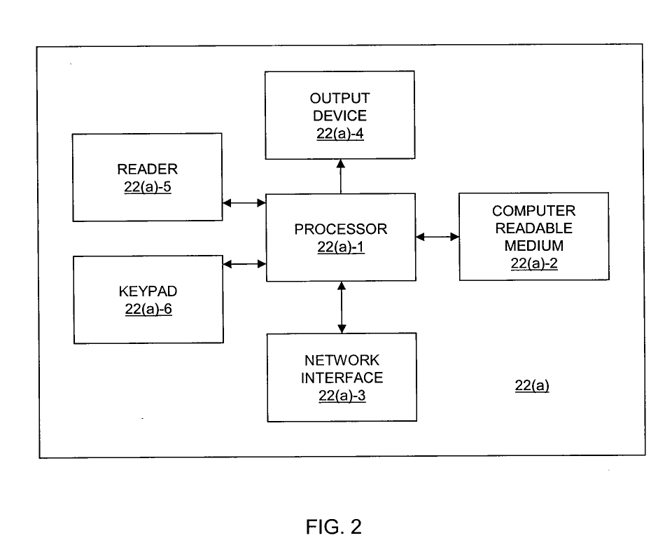

FIG. 2 shows an exemplary block diagram of some elements that may be present in an access device according to an embodiment of the invention. The access device 22(a) can be configured to interact with portable consumer devices such as credit cards, debit cards, stored value cards, contactless fobs, cell phones, etc.

As shown in FIG. 2, the access device 22(a) may comprise a processor 22(a)-1, and a computer readable medium 22(a)-2, a network interface 22(a)-3, an output device 22(a)-4, a reader 22(a)-5, and a keypad 22(a)-6 operatively coupled to the processor 22(a)-1.

The processor 22(a)-1 may be embodied by one or more microprocessors, and the computer readable medium 22(a)-2 may use any suitable electrical, magnetic or optical means of data storage. The computer readable medium 22(a)-2 may store computer code for performing the functions of the access device 22(a).

The network interface 22(a)-2 may be any suitable interface that will allow the access device 22(a) to communicate with external apparatuses. The network interface 22(a)-2 can allow the access device 22 to communicate with the acquirer 24 and the payment processing network 26.

The reader 22(a)-5 may include any suitable contact or contactless mode of operation. For example, exemplary card readers can include RF (radio frequency) antennas, magnetic stripe readers, etc. to interact with a portable consumer device such as a credit card or debit card. The reader 22(a)-5 may be used to enter bill information into the access device 22(a).

The keypad 22(a)-6 may be an ordinary keypad that is associated with a POS terminal. The keypad 22(a)-6 may be embodied by a number of depressible buttons, or could be embodied on a touchscreen on a display. The keypad 22(a)-6 may be used to enter bill information into the access device 22(a).

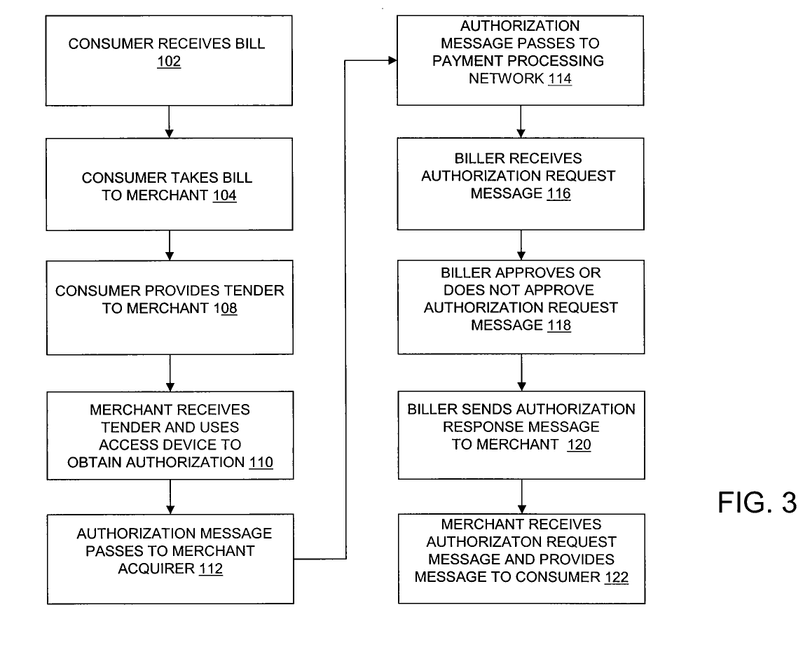

Referring to FIGS. 1-5, in a typical method according to an embodiment of the invention, a consumer 30 receives a bill 30 from a biller 32 (step 102 in FIG. 3). The consumer 30 may receive the bill 30 in any suitable manner. For example, the bill 30 may be sent from the biller 32 using any suitable process including postal mail, e-mail, courier, etc.

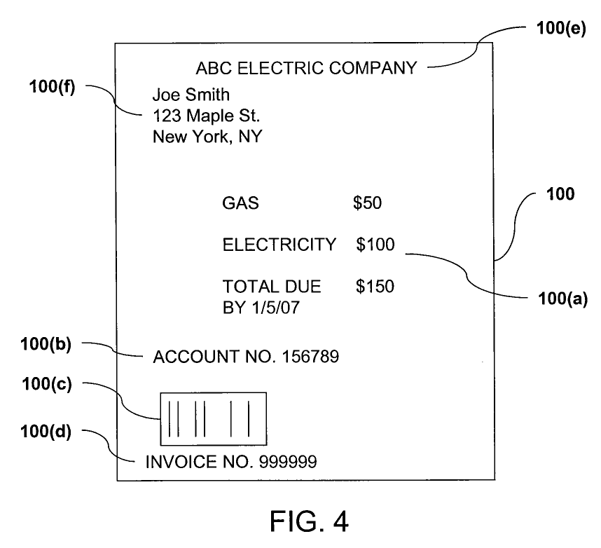

An exemplary bill 100 is shown in FIG. 4. The bill 100 may be in the form of paper and may have the following: an itemized list of charges with a total amount due 100(a), an account number 100(b), an optional bar code 100(c) identifying the bill, a bill or invoice number 100(d), the name of the biller 100(e), and the address of the consumer 100(f).

After the consumer 30 receives the bill 100, the consumer 30 takes the bill to the merchant 22 (step 104 in FIG. 3) to pay the bill 100. The consumer 30 then shows the bill to the merchant 22 and provides tender to the merchant 22 (step 108 in FIG. 3).

The tender provided by the consumer 30 to the merchant 22 may be in any suitable form. In preferred embodiments, the tender that is provided to the merchant 22 is in the form of cash. However, the tender that is provided could be in the form of a check, or payment card (e.g., a debit or credit card).

The merchant 22 then receives the tender and uses the access device 22(a) to obtain authorization (step 110 in FIG. 3). In one embodiment, the merchant 22 (which would include an employee of the merchant 22) may manually key in the invoice number (see 100(d) in FIG. 4) into the keypad (see 22(a)-6 in FIG. 2) in the access device 22(a). The merchant 22 may also enter the amount tendered and/or the amount due.

In another embodiment, the merchant 22 may use a reader (see 22(a)-5 in FIG. 2) in the access device 22(a) to read the bar code 100(c) on the bill 100. The merchant 22 may also optionally key in the amount tendered by the consumer 30. The bar code 100(c) may be used to identify the bill 100 so that information need not be manually keyed in by the merchant 22. Although a bar code is shown for purposes of illustration, it is understood that any machine readable technology (e.g., an RF chip) could be used to identify the bill 100 to the access device 22(a) and the system in general.

After the access device 22(a) receives information about the bill 100 and the amount tendered by the merchant 22, an authorization request message is generated by the access device 22(a). The authorization request message is then sent from the access device 22(a) to the merchant acquirer 24 (step 112 in FIG. 3), and is subsequently sent from the acquirer 24 to the payment processing network 26 (step 114 in FIG. 3), and then to the biller 32.

After the biller 32 receives the authorization request message, the biller 32 analyzes the authorization request message and either approves or does not approve of the payment (step 118 in FIG. 3).

The biller 32 then generates and sends an authorization response message back to the merchant 22 via the payment processing network 26 and the acquirer 24 (step 120 in FIG. 3). The biller 32 may also credit the consumer's account.

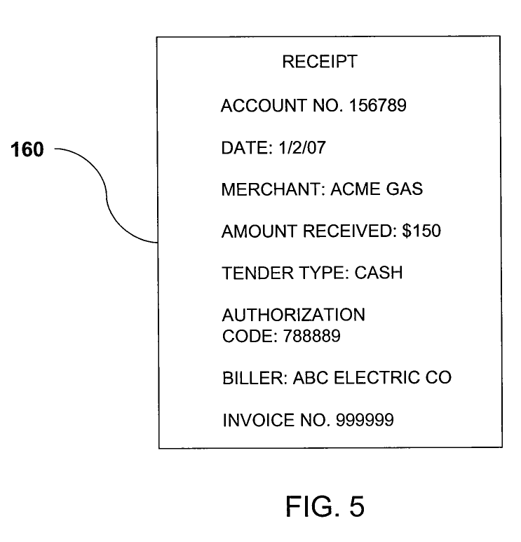

After the merchant 22 receives the authorization response message, the access device 34 at the merchant 22 may then provide the authorization response message for the consumer 30. The response message may be displayed by the access device 34, or may be printed out on a receipt. An example of a receipt 160 that the consumer 30 might receive is shown in FIG. 5.

At the end of the day, a normal clearing and settlement process can be conducted by the transaction processing network 26. In the clearing and settlement process, the payment processing network 26 consolidates various transactions between different billers, acquirers and issuers and settles accounts among them. In conventional clearing and settlement processes, billers such as utilities do not participate. During the clearing and settlement process according to embodiments of the invention, actual funds can be transferred from the acquirer 24 to the biller acquirer 30 or directly to the biller 32. This process is usually completed within one or three days from the date that the bill was paid by the consumer.

In embodiments of the invention, various parties may incur transaction costs. In one embodiment, the consumer 30 may pay a fee (e.g., 5% of the amount of the bill payment, or less) to the merchant 22 for the convenience of using the merchant 22 and/or an entity maintaining the payment processing network 26 for making the transaction possible. In another embodiment, the biller 32 may pay a fee to the merchant (or its acquirer) 22 and/or entity maintaining the payment processing network 26. In yet another embodiment, both the consumer 30 and the biller 32 may pay part of the transaction fee to the merchant 22. Lastly, in some cases, the merchant 22 may not even receive a fee for performing the bill payment service, since the merchant 22 may experience a greater number of customers, because it provides the described bill payment service.

Embodiments of the invention have a number of advantages. First, as noted above, in embodiments of the invention, a consumer can pay a bill at any suitable merchant location. This makes it more convenient for the consumer to pay a biller's bill and more likely that the biller's bill will get paid. Second, by using a two step bill payment process (e.g., transaction authorization and subsequent clearing and settlement), the system has the capability of declining bill payment transactions that are somehow erroneous before funds are received by the merchant. This reduces the risk of accounting problems. Also, by participating in the system which can also process traditional credit and debit card transactions, the biller 32 can essentially be guaranteed that it will be paid once it approves of the bill payment in the transaction authorization process. Third, using embodiments of the invention, the consumer 30 could essentially pay at the “last minute” and still pay his bill on time. This cannot be done with certainty using a payment mechanism such as a check. Fourth, embodiments of the invention can use an existing payment processing network for bill payment, and substantial modifications to that system are not needed. Merchant terminals would also not need substantial hardware or software changes, since protocols that are similar to those used for ordinary credit and debit card processing can be used (although some changes may need to take place at the merchant terminals).

The terms and expressions which have been employed herein are used as terms of description and not of limitation, and there is no intention in the use of such terms and expressions of excluding equivalents of the features shown and described, or portions thereof, it being recognized that various modifications are possible within the scope of the invention claimed. Moreover, any one or more features of any embodiment of the invention may be combined with any one or more other features of any other embodiment of the invention, without departing from the scope of the invention.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

One or more features from any embodiment may be combined with one or more features of any other embodiment without departing from the scope of the invention.

A recitation of “a”, “an” or “the” is intended to mean “one or more” unless specifically indicated to the contrary.

What is claimed is:

1. A method comprising:
receiving a bill from a biller;
presenting tender to a merchant to pay the bill, wherein the merchant thereafter sends an authorization request message to the biller, and the biller thereafter authorizes or does not authorize payment of the bill, and then sends an authorization response message back to merchant, wherein the authorization response message indicates whether or not the biller has authorized or not authorized the payment of the bill; and
reviewing the authorization response message.

2. The method of claim 1 wherein the authorization response message indicates that the biller has authorized the payment of the bill and wherein the method further comprises:
receiving a receipt from the merchant indicating that the bill was paid.

3. The method of claim 1 wherein the bill is a utility bill.

4. The method of claim 1 wherein the authorization response message is sent through a payment processing network that is configured to process debit and credit card transactions.

5. A method comprising:
sending an authorization request message to a biller, wherein the authorization request message requests authorization for a consumer to pay a bill at the merchant, wherein the biller thereafter authorizes or does not authorize payment of the bill, and then sends an authorization response message back to the merchant, wherein the authorization response message indicates whether or not the biller has authorized or not authorized the payment of the bill; and
receiving the authorization response message.

6. The method of claim 5 further comprising:
receiving tender from the consumer to pay the bill; and
entering an identifier for the bill into an access device at the merchant.

7. The method of claim 6 wherein the tender comprises cash.

8. The method of claim 6 wherein the authorization response message is sent through a payment processing network that is configured to process debit and credit card transactions.

9. A computer readable medium comprising code for performing the method of claim 6.

10. An access device comprising the computer readable medium of claim 9.

11. A method comprising:
receiving an authorization request message from a merchant, wherein the authorization request message requests authorization for a consumer to pay a bill at the merchant, wherein the bill was previously issued by a biller; and
sending an authorization response message to the merchant, wherein the authorization response message indicates whether or not the biller has authorized or not authorized the payment of the bill.

12. The method of claim 11 sending the authorization response message comprises sending the authorization response message through a payment processing network that is configured to process debit and credit card transactions.

13. The method of claim 11 further comprising:
performing a clearing and settling process which involves an acquirer associated with the merchant and the biller.

14. A computer readable medium comprising code for performing the method of claim 11.

15. A server computer comprising the computer readable medium of claim 14.

16. A system comprising:
means for sending an authorization request message to a biller, wherein the authorization request message requests authorization for a consumer to pay a bill at the merchant, wherein the biller thereafter authorizes or does not authorize payment of the bill, and then sends an authorization response message back to merchant, wherein the authorization response message indicates whether or not the biller has authorized or not authorized the payment of the bill; and
means for receiving the authorization response message.

17. The system of claim 16 wherein the bill is a utility bill.

18. The system of claim 16 further comprising means for performing a clearing and settlement process, wherein the clearing and settlement process involves the biller and an acquirer of the merchant.

19. A system comprising:
means for sending an authorization request message to a biller, wherein the authorization request message requests authorization for a consumer to pay a bill at the merchant, wherein the biller thereafter authorizes or does not authorize payment of the bill, and then sends an authorization response message back to merchant, wherein the authorization response message indicates whether or not the biller has authorized or not authorized the payment of the bill; and
means for receiving the authorization response message.

20. The system of claim 18 wherein the bill is a utility bill.
